(19) United States
(12) Patent Application Publication
(10) Pub. No.: US 2003/0133670 A1
(43) Pub. Date: Jul. 17, 2003

(54) Fiber optic alignment device

(76) Inventors: Christopher John Frye, Orefield, PA (US); Michael S. Hahn, Allentown, PA (US)

Correspondence Address: FRANK A. CONA, MILLER & CHRISTENBURY, 44TH FLOOR, 1650 MARKET ST., PHILADELPHIA, PA, 19103, US

(21) Appl. No.: 10/050,295

(22) Filed: Jan. 16, 2002

(51) Int. Cl. G02B 6/36; G02B 6/26

(52) U.S. Cl. 385/77; 385/78; 385/52

(57) ABSTRACT

The present invention is directed to a system for aligning optical fibers inserted into a faceplate hole or cavity in a fiber optic array. A plurality of flexible protrusions may be included, which extend inwardly from the inner perimeter of the cavity to contact the optical fiber as it is inserted into the cavity. The protrusions are substantially uniformly deformed by the insertion of the optical fiber into the cavity to align the optical fiber therein. In the preferred embodiment, the protrusions are three equally distant flanges extending the length of the cavity, which are tapered in relation to each other such that the spacing of the flanges at the faceplate is nominally small than the outside diameter of the optical fiber. The present invention also includes a method for producing the alignment device, which includes applying a mask to a substrate, where the mask is shaped as having a plurality of protrusions extending inwardly from an inner perimeter of a cavity; and etching the substrate to create a plurality of protrusions extending inwardly from an inner perimeter of a cavity in the substrate, wherein the protrusions in the cavity are sized to substantially uniformly to form to align the optical fiber when inserted into the cavity. The etching may be accomplished using a number of processes, such as RIE and photolithograpy.

### CROSS-REFERENCE TO RELATED APPLICATION

Not applicable.

### STATEMENT REGARDING FEDERALLY SPONSORED RESEARCH

Not applicable.

### REFERENCE TO MICROFICHE APPENDIX

Not applicable.

### BACKGROUND OF THE INVENTION

1. Field of the Invention

The present invention relates to a fiber optic alignment device. More particularly, the present invention relates to a device used to align optical fibers in a fiber array. Even more particularly, the present invention involves a kinematic spring used to align single or multi mode optical fibers in a fiber optic array.

2. Description of the Prior Art

Historically, fiber optic arrays have been produced by etching grooves on a Silicon wafer or metal plate by photolithography or similar methods and then bonding the optical fibers into the grooves. Multi-port fiber arrays could then be created by bonding multiple layers together.

However, one of the most important uses of fiber arrays today is in optical switches, in which the alignment of the fibers in the array is critical. Because of the high degree of inaccuracy in aligning the fibers in the groove bonding system of manufacture, multi-port fibers arrays have more recently been produced by etching multiple layers of holes in a bulk substrate material and inserting the fibers therein.

An example of such a manufacturing system is shown in U.S. Pat. No. 6,181,864, incorporated by reference herein. The '864 patent discloses a method of producing a fiber array by forming holes in a silicon wafer or ceramic substrate at predetermined intervals, plating the walls of the holes and the entire surface of the substrate with the solder alloy material, inserting metal-coated optical fibers into the holes plated with the solder alloy material, and positioning the optical fibers at the centers of the holes using the surface tension of the solder alloy material. The optical fibers are then fixed within the substrate using a curable epoxy and polished.

Such prior art systems have the significant disadvantage that alignment of the fiber within the substrate is poor, due to the fact that the inner diameter of the hole is of necessity much greater than the outer diameter of the fiber, in order to allow the fiber to be inserted into the bore and bonded thereto.

As one alternative, the diameter of the borehole is reduced to achieve a tighter tolerance for the inserted fiber, but must still be large enough to ensure that the fiber will not break or fracture during insertion. However, the necessary gap still results in misalignment of the fiber ends. To compensate for this, the fiber ends are typically tapered and the end hole in the faceplate of the bulk substrate reduced to further tighten the tolerance of the hole to the inserted fiber. In this method, the tapered fiber ends protrude through the faceplate after assembly and must be individually ground and polished, creating further alignment inaccuracies due to variations in the polishing process and adding significantly to the cost of production.

Accordingly, a system is needed in which optical fibers can be accurately aligned within a bored substrate material without the need to re-grind and polish the fiber ends after insertion and without the danger of breakage or fracture.

### SUMMARY OF THE INVENTION

The present invention is directed to a system for aligning optical fibers inserted into a faceplate hole or cavity in a fiber optic array. A plurality of flexible protrusions may be used, which extend inwardly from the inner perimeter of the cavity to contact the optical fiber as it is inserted therein. The protrusions are substantially uniformly deformed by the insertion of the optical fiber into the cavity to align the optical fiber. In the preferred embodiment, the protrusions are three equally distant flanges extending the length of the cavity, which are tapered in relation to each other such that the spacing of the flanges at the faceplate is nominally smaller than the outside diameter of the optical fiber.

The present invention also includes a method for producing the alignment device, which includes applying a mask to a substrate, where the mask is shaped as having a plurality of protrusions extending inwardly from an inner perimeter of a cavity; and etching the substrate to create a plurality of protrusions extending inwardly from an inner perimeter of a cavity in the substrate, wherein the protrusions in the cavity are sized to substantially uniformly to form to align the optical fiber when inserted into the cavity. The etching may be accomplished using a number of processes, such as RIE and photolithograpy.

### BRIEF DESCRIPTION OF THE DRAWINGS

FIG. 1 is an isometric drawing of a fiber optic array in which the preferred embodiment of the invention is used.

FIG. 2(a) is an isometric drawing of a single cavity in a fiber optic array containing the preferred embodiment of the invention.

FIG. 2(b) is a cross-section along line A-A of FIG. 2(a).

FIG. 3(a) also is an isometric drawing of a single cavity in a fiber optic array containing the preferred embodiment of the invention.

FIG. 3(b) is a cross-section along line B-B of FIG. 3(a) illustrating the insertion of an optical fiber into a cavity containing the preferred embodiment of the invention.

FIG. 3(c) is a cross-section along line B-B of FIG. 3(a) showing the fully inserted and aligned optical fiber in accordance with the present invention.

### DETAILED DESCRIPTION OF THE PREFERRED EMBODIMENT

The present invention will be understood more fully from the detailed description given below and from the accompanying drawings of preferred embodiments of the invention, which, however, should not be taken to limit the invention to a specific embodiment, but are for explanation and understanding only.

One of the most important uses of fiber optic arrays today is in optical switches. It is critically important that the alignment of the fibers in the array is as accurate as possible. Improper alignment can lead to variations in signal loss and interference at the output of the array due to misalignment of the output light in relation to the succeeding receiving components (typically a lens or a lens array). Misalignment can significantly increase error rates in transmitted data or loss of data altogether. The present invention significantly reduces these problems by providing a system for accurately aligning the fibers within each array cavity.

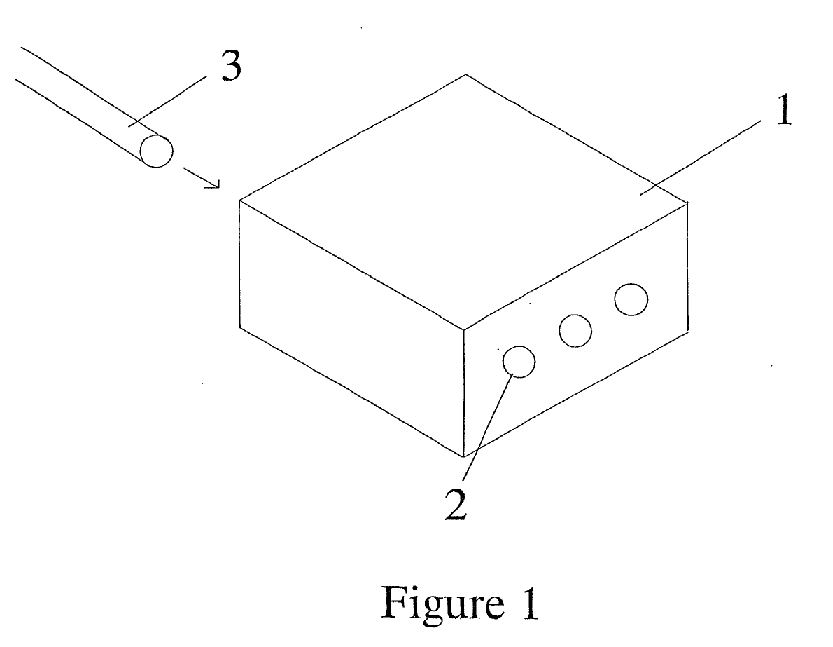

A fiber optic array in the manner of the prior art is shown in FIG. 1. The array is comprised of a substrate (1) that contains a plurality of holes or cavities for mounting the optical fibers. Each cavity (2) typically contains a single fiber and is configured into one or more rows within substrate (1) as previously described. Substrate (1) may, of course, comprise any number or well-known materials including silicon, ceramics, or metal oxides.

Once cavity (2) has been formed, each optical fiber (3) is inserted and mounted therein to form the array. Optical fiber (3) may comprise any number of well known fibers types, including single mode, multi-mode or graded index (“GRIN”) fibers. The fibers are typically composed of silica or other glasses, polymers, and the like. It will be appreciated that the present invention is not limited to any one particular type of fiber, and can be used with any optical fiber capable of being inserted into cavity (2).

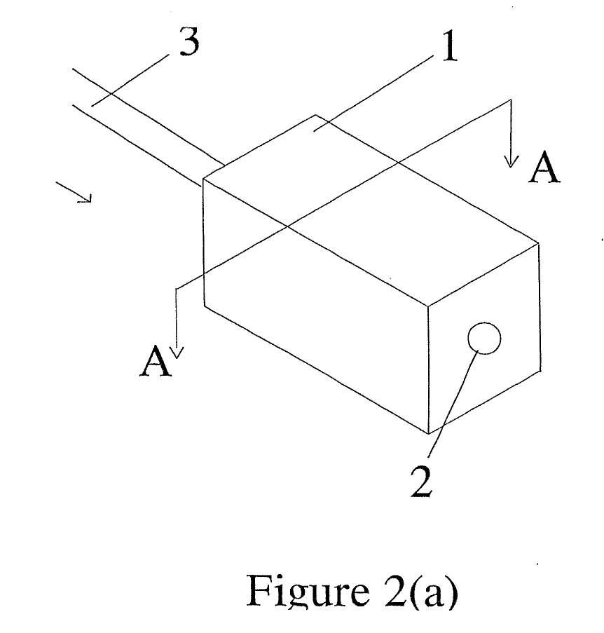

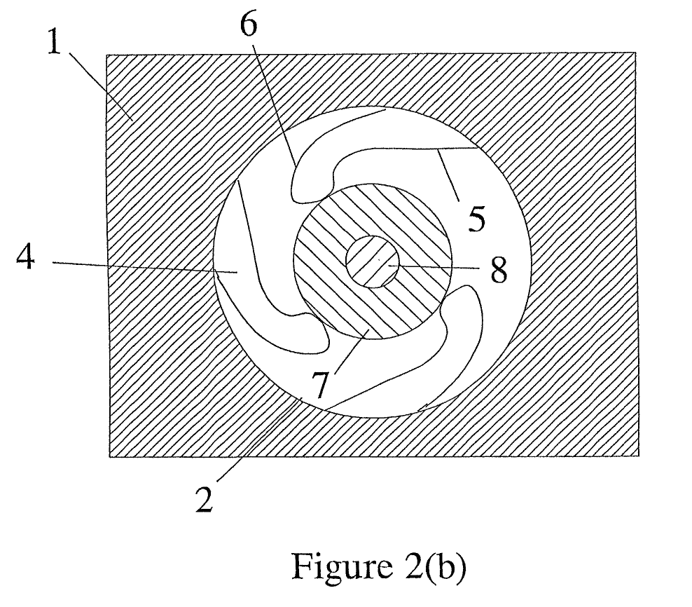

The present invention will now be described in more detail in regard to a single cavity within the previously described fiber array. FIG. 2(a) illustrates a single fiber cavity having an optical fiber inserted therein. As shown in FIG. 2(a) optical fiber (3) is gradually inserted through cavity (2) in substrate (1). Typically, optical fiber (3) is inserted until it is flush with the end faceplate of substrate (1) or slightly protruding therefrom. Once optical fiber (3) is completely inserted, substrate (1) and optical (3) fiber are typically polished and coated with anti-reflective material.

FIG. 2(b) is a cross-section along line A-A of FIG. 2(a), as optical fiber (3) is being inserted into substrate (1). As shown in FIG. 2(b), cavity (2) contains a plurality of protrusions (4), which contact and engage optical fiber (3) as it passes therethrough. In the preferred embodiment of the invention, the inner perimeter of cavity (2) contains a plurality of equally spaced flanges comprising arm (5) and lip (6), which extend inwardly from the inner perimeter of cavity (2) at an angle as shown. It is preferred that arm (5) and lip (6) are sized and extended at an angle such that the space formed between each of the lips (6) is nominally smaller than the diameter of optical fiber (3).

In the embodiment shown in FIG. 2(b), optical fiber (3) comprises a single outer cladding (7) and core (8). However, one of ordinary skill in the art will appreciate that the present invention is not limited thereto.

By forming the space between lip (6) to be slightly smaller than the diameter of fiber cladding (7), protrusions (4) are made to flex outward slightly against the resistance of optical fiber (3) in a kinematic spring like fashion. By substantially uniformly placing protrusions (4) within cavity (2), optical fiber (3) is properly aligned within cavity (2) as it passes therethrough.

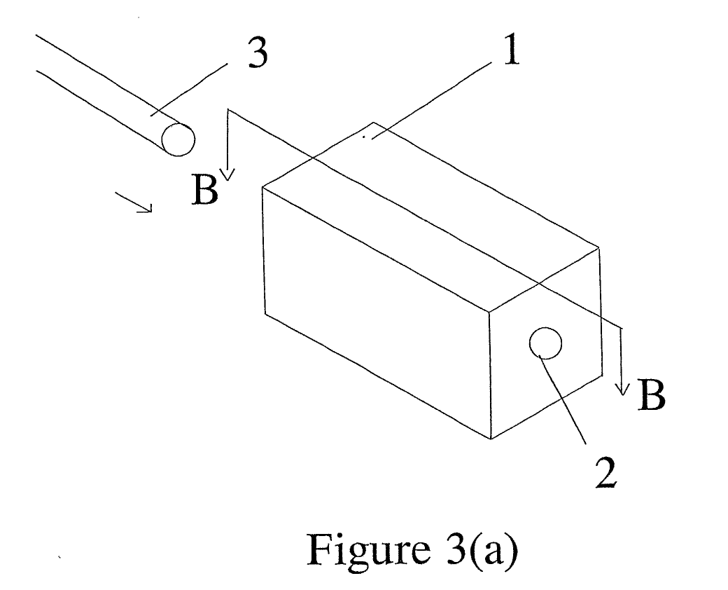

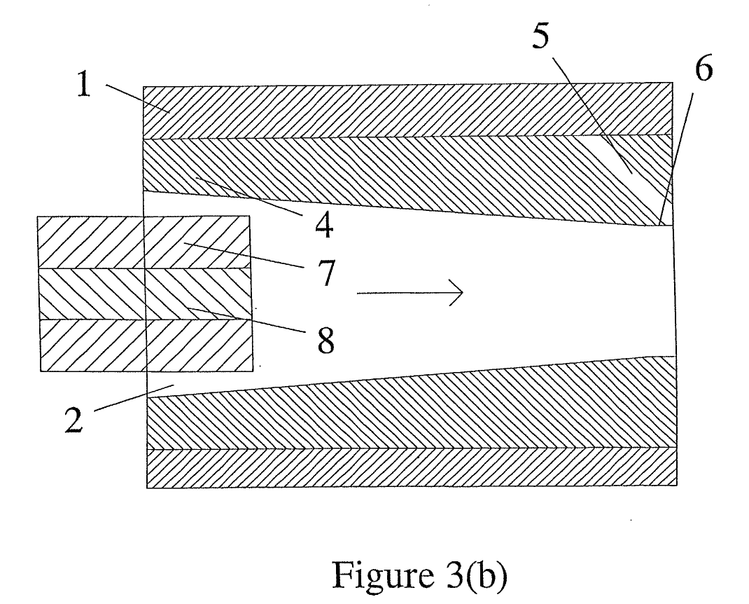

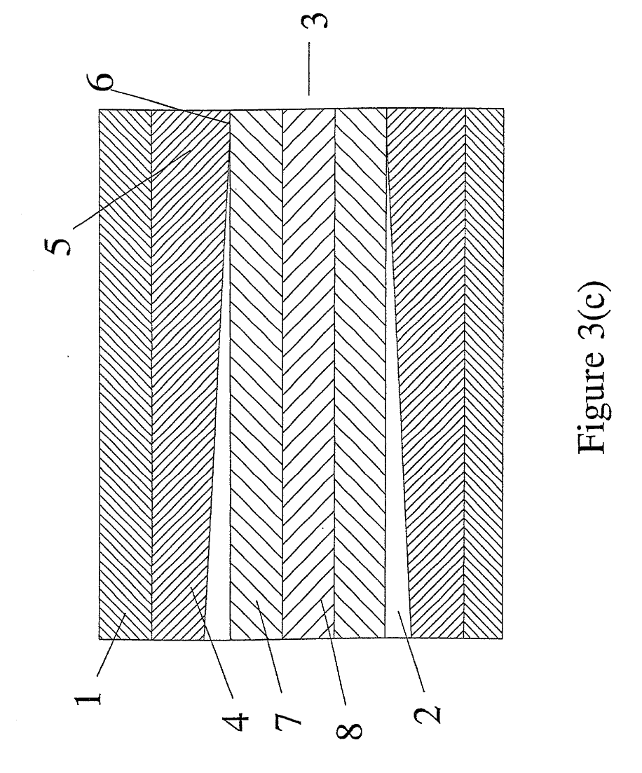

FIG. 3(a) again shows an isometric view of a single cavity of a fiber array having an optical fiber inserted therethrough. FIG. 3(b) is a cross-section along line B-B of FIG. 3(a) as optical fiber (3) is being inserted into cavity (2). As shown in FIG. 3(b), protrusions (4) are preferably tapered from one end of cavity (2) to the other such that the spacing between each of protrusions (4) is slightly smaller than the diameter of optical fiber (3) at one end of cavity (2) and slightly larger than optical fiber (3) at the other. As optical fiber (3) is inserted into cavity (2) it is effectively guided into alignment as it contacts protrusions (4). In the preferred embodiment of the invention, protrusions (4) are spaced such that optical fiber (3) is aligned along the center line of cavity (2). Of course, the configuration of protrusions (4) in the system of the present invention is not limited thereto.

As also illustrated in FIG. 3(b), protrusions (4) are spaced such that they do not overlap or come in contact with core (8), but only with cladding (7). This is preferred, in that it substantially reduces the risk of damage to the fiber core, and the cladding immediately surrounding the core, substantially eliminating the need to repolish the fiber.

FIG. 3(c) is a cross-section along line B-B of FIG. 3(a) showing optical fiber (3) completely inserted into cavity (2) until it is flush with the faceplate of substrate (1). Protrusions (4) have contacted and engaged optical fiber (3) along its length and have properly aligned it therein.

The cavity intrusions may be formed within the array substrate in any number of conventional manners known to those of ordinary skill in the art, such as by conventional photolithography, or, more preferably, by a reactive ion etching (RIE) process. In an RIE process, a pattern mask is preferably applied to the silicon that is appropriately shaped to have a plurality of protrusions extending inwardly from an inner perimeter of a cavity. The silicon wafer is thereafter typically placed on an rf electrode in a plain or parallel plate reactor. Ions are accelerated against the wafer by the DC potential between the plasma and the cathode, etching the silicon to have the desired shape.

Although this invention has been described with reference to particular embodiments, it will be appreciated that many variations may be resorted to without departing from the spirit and scope of this invention. For example, while the invention has been described in relation to a single row array, the system of the present invention may be used in connection with a single fiber, or a two dimensional array. In addition, the substrate of the present invention is not limited to silicon or other conventionally used materials, but may comprise any material capable of being shaped in the manner claimed.

We claim:

1. An apparatus for aligning optical fibers within an inner perimeter of a cavity comprising:
a plurality of flexible protrusions extending inwardly from said inner perimeter of said cavity to contactingly engage an optical fiber inserted into said cavity;
wherein said protrusions are substantially uniformly deformed by the insertion of said optical fiber into said cavity to align said optical fiber therein.

2. The apparatus of claim 1, wherein each of said plurality of protrusions comprise a flange having an arm and a lip.

3. The apparatus of claim 1, wherein said plurality of protrusions are spaced from each other at a distance smaller than the diameter of said optical fiber.

4. The apparatus of claim 1, wherein said plurality of protrusions are tapered along said cavity.

5. The apparatus of claim 1, wherein said plurality of protrusions extend the entire length of said cavity.

6. The apparatus of claim 1, wherein said plurality of protrusions are tapered along said cavity from a spacing less than the diameter of said optical fiber to a spacing greater than the diameter of said optical fiber.

7. The apparatus of claim 1, wherein said protrusions are formed by the creation of said cavity.

8. An apparatus for aligning optical fibers in relation to the inner perimeter of a cavity comprising:
a plurality of flexible flanges extending inwardly from said inner perimeter of said cavity, said flanges having a arm and a lip, wherein said flange lip contactingly engages said optical fiber as it is inserted into said cavity;
wherein said flexible flanges are substantially uniformly deformed by the insertion of said optical fiber into said cavity to align said optical fiber therein.

9. A method of aligning optical fibers within an inner perimeter of a cavity comprising the steps of:
creating a plurality of protrusions extending inwardly from said inner perimeter of said cavity;
inserting an optical fiber into said cavity to contactingly engage said protrusions; and
fully inserting said optical fiber into said cavity to substantially uniformly deform said protrusions to align said optical fiber within said cavity.

10. The method of claim 9, wherein said protrusions comprise a flange having an arm and a lip.

11. The method of claim 9, wherein said plurality of protrusions are spaced apart from each other at a distance smaller than the diameter of said optical fiber.

12. The method of claim 9, wherein said plurality of protrusions are tapered along said cavity.

13. The method of claim 9, wherein said plurality of protrusions extend the entire length of said cavity.

14. The method of claim 12, wherein said plurality of protrusions are tapered along said cavity from a spacing less than the diameter of said optical fiber to a spacing greater than the diameter of said optical fiber.

15. The method of claim 9, wherein said protrusions are formed by the creation of said cavity.

16. A method of creating an apparatus for aligning optical fibers in a substrate comprising the steps of:
applying a mask to said substrate, said mask being shaped as having a plurality of protrusions extending inwardly from an inner perimeter of a cavity; and
etching said substrate to create a plurality of protrusions extending inwardly from an inner perimeter of a cavity in said substrate;
wherein said protrusions and said cavity are sized to substantially uniformly deform to align to an optical fiber inserted within said cavity.

17. The method of claim 16, wherein said etching is accomplished using an RIE process.

18. The method of claim 16, wherein said process is accomplished using photolithography.

19. The method of claim 16, wherein said protrusion comprises a flange having an arm and a lip.

20. The method of claim 16, wherein said protrusions are tapered along said cavity from a spacing less than the diameter of said optical fiber to a spacing greater than the diameter of said optical fiber.
